(19) United States
(12) Patent Application Publication
(10) Pub. No.: US 2002/0146038 A1
(43) Pub. Date: Oct. 10, 2002

(54) Method and apparatus for inserting local data into a broadcast stream

(76) Inventors: Scott Casavant, Germantown, MD (US); Bharath Venkataraman, Germantown, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/826,505

(22) Filed: Apr. 5, 2001

(51) Int. Cl. H04J 1/00

(52) U.S. Cl. 370/486; 370/538

(57) ABSTRACT

A method and system including a broadcast and a local information source, a headend, and a link are described for providing local information to a user device. A broadcast information stream generated at a first data rate is received at the headend. Local information packets are inserted at the headend into the broadcast information stream forming a combined information stream which is transmitted to the user device at a different data rate. Alternatively, local information packets are inserted in place of unusable packets in a broadcast information stream to form a combined information stream which is transmitted to the user device. The user device may be, a display, a, computer, a VCR, a DVR, a set-top box, or a TV.

### BACKGROUND OF THE INVENTION

1. Field of the Invention

Technical Field of the Invention

The present invention relates to multiplex communications. In particular the present invention relates to packet insertion for local information in a broadcast stream.

2. Background of the Invention

Description of Related Art

Modern cable networks now carry a variety of programming which typically includes a combination of, for example, nationally syndicated programming and local programming. In a typical cable television network broadcast information is received at a headend and disseminated to various subscribers via, for example, set-top boxes. Problems arise in providing local information received separately from the broadcast information.

Typical methods of addressing the problem of adding local data include adding a channel dedicated to the purpose of transmitting local data. Some systems, for example, specify the use of out of band (OOB) channels to carry local data. Such methods have disadvantages including, for example, the extra bandwidth required in adding an additional dedicated channel and the increase in cost of hardware required at each set-top box in order to tune in the additional dedicated channel. Additional costs in the set-top box are particularly undesirable due to the large number of set-top boxes typically included in a cable network.

Thus, it would be appreciated in the art for a method and apparatus to insert local data into a broadcast stream without increasing the cost of the general-purpose set-top box or increasing the bandwidth requirements.

### SUMMARY OF THE INVENTION

Accordingly, a method and system are described for providing local information to a user device. The system preferably includes a broadcast information source, a local information source, a headend, and a link between the headend and the user device.

In accordance with various exemplary embodiments, the broadcast information source may generate a broadcast information stream at a first data rate, which stream may be received at the headend. One or more packets from a local information stream generated by the local information source may be inserted at the headend into the broadcast information stream to form a combined information stream. The combined information stream may then be transmitted to the user device at a data rate faster than the data rate at which the broadcast information stream is generated. Alternatively, a broadcast information stream at a first data rate and a local information stream may be combined to form a combined information stream at a second data rate faster than the first data rate, which combined information stream is received at the user device configured in accordance with exemplary embodiments of the present invention.

Further in accordance with alternative exemplary embodiments of the present invention a broadcast information stream including one or more packets unusable to the user device may be received, for example, at a headend, and one or more local information packets inserted in place of the unusable packets to form a combined information stream. The combined information stream may then be transmitted to the user device. It should be noted that in accordance with various exemplary embodiments, the user device may include, for example, a display, a computer, a VCR, a DVR, a set-top box, and a TV.

### BRIEF DESCRIPTION OF THE DRAWINGS

The present invention will become more fully understood from the detailed description given herein below and the accompanying drawings, which are given by way of illustration only, and thus are not limitative of the present invention, and wherein:

FIG. 1 is a block diagram illustrating information flow associated with a broadcast information source;

FIG. 2 is a diagram illustrating insertion of local information in accordance with various exemplary embodiments of the present invention;

FIG. 3 is a diagram further illustrating insertion of local information in accordance with various exemplary embodiments of the present invention;

FIG. 4 is a blocked diagram illustrating an exemplary set-top box for receiving broadcast and local information in accordance with various exemplary embodiments of the present invention.

### DETAILED DESCRIPTION OF THE DRAWINGS

In accordance with various exemplary embodiments of the present invention, data may be passed between a headend (HE) and a set-top box (STB) using a transport mechanism. It should be noted that data to be passed may be packetized and inserted into the transport stream.

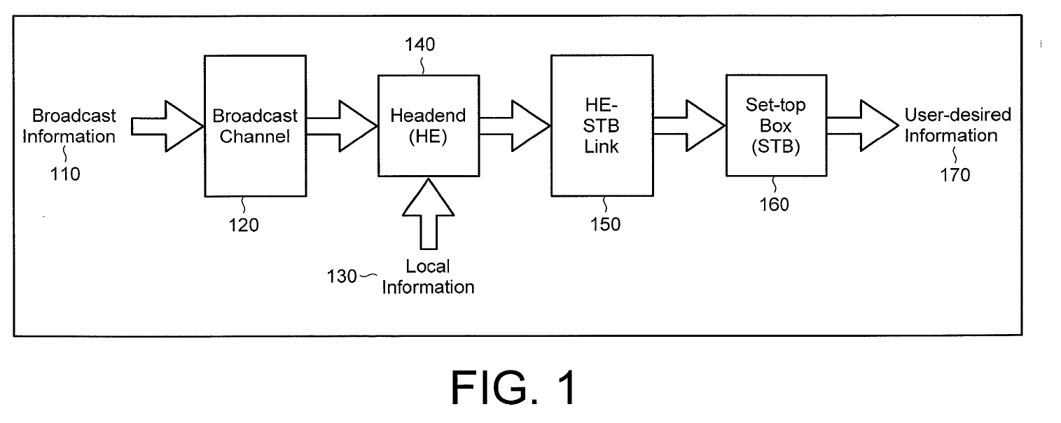

Thus a basic system for disseminating broadcast information is illustrated in FIG. 1. Therein it can be seen that broadcast information 110 which may include a wide variety of programming information and like data originating from, for example, a cable or satellite broadcast network may be communicated on broadcast channel 120 to headend (HE) 140. As will be appreciated by those skilled in the art, HE 140 is preferably a point in a service provider's delivery system where a one-to-many distribution of a programming source channel or channels takes place.

Local information 130 may be combined with broadcast information 110 at HE 140 to be communicated to set-top box (STB) 160 along headend set-top box (HE STB) link 150. Accordingly, user desired information 170 may be made available to a user for display or review in a number of formats, e.g. data, video, audio, audio plus video, Internet data, and the like. It should be noted that while HE 140 is illustrated as receiving broadcast information 110 over broadcast channel 120 additional broadcast streams may be received by HE 140. Furthermore, in accordance with various alternative exemplary embodiments, STB 160 is only one example of a user device which may receive information. Other examples include a display, a VCR, a digital playback and/or recording device such as a DVR, a set-top box, and a TV personal computer (PC), TV or hardware card which may be added to an existing apparatus such as a conventional set-top box, PC or TV. Still further, functionality in accordance with the present invention may be downloaded or otherwise programmed into a set-top box, PC or TV which otherwise would not be configured to carry out such functions.

Since broadcast channels such as, for example, broadcast channel 120 received by HE 140, in accordance with the present invention may contain additional broadcast streams, broadcast channel 120 may be mapped differently, e.g. to different frequencies, before transmission to STB 160. Thus, in addition to the combination of broadcast information 110 and local information 130, STB 160 may further receive information on the mapping of broadcast information and local information. Channel mapping information enables set-top box to resynchronize in the event of, for example, power loss, loss of signal lock, remapping of channels, and the like. By providing a local mapping, a provider of local information 130 may custom tailor the system to add information of local but not national interest.

Thus in accordance with various exemplary embodiments of the present invention local information may be added by forming regular transport packets in HE 140. Packet size may typically be, for example, 188 bytes in the case of a DVB system and, for example, 130 bytes in the case of, for example, DIRECTV®. Once formed in regular transport packets, local information may be passed to STB 160 on transport channels using one or more of the following exemplary methods:

### Example 1

Configuring HE 140 to send out information to STB 160 along HE STB link 150 at a faster rate than the rate at which, for example, broadcast information 110 is being received. Time intervals created by the difference in transmission rate may be used to send out packets of local information; and

### Example 2

Inserting local information 130 at HE 140 in place of erroneous, unneeded, or blank packets.

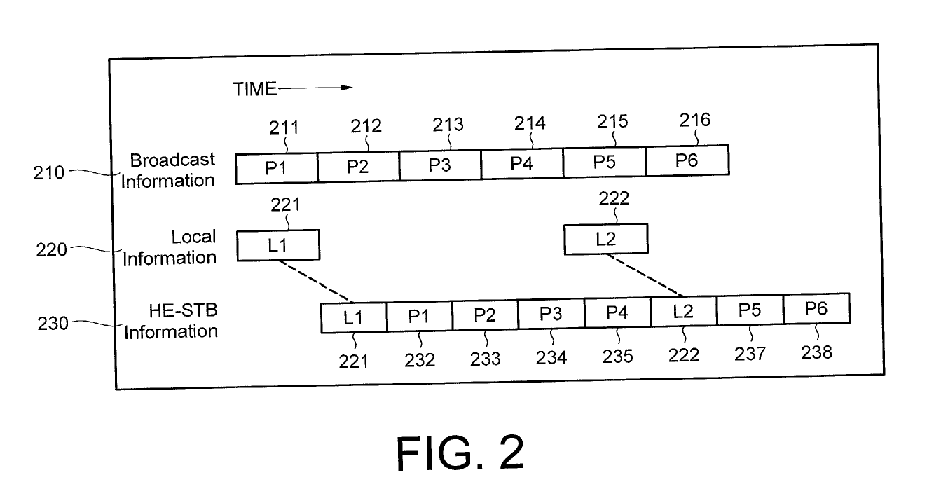

In accordance with the first exemplary method as described herein above FIG. 2 illustrates broadcast information stream 210 consisting of packets P1 211-P6 216. It should be noted that according to the present example, broadcast information stream 210 may be transmitted at a variety of symbol rates, for example, 20Msps (symbols per second) and local information stream 220, including local packets L1 221 and L2 222 may also be transmitted at a variety of rates, for example, 1 packet for every 4 incoming broadcast packets or approximately 5Msps. HE STB link 150 may then be run at 25Msps to accommodate both broadcast information stream 210 and local information stream 220 which are combined to produce HE STB stream 230. The rate of broadcast information stream 210 and local information stream 220 may also be expressed for example, as a data rate, e.g. in bits per second (bps). In accordance with preferred exemplary embodiments, broadcast data may be transferred at 30 Mbps and location information transferred at less than 100 kbps. It should also be noted that in accordance with the present exemplary method any amount of local information on local information stream 220 may be conveyed up to the maximum speed as established by the transmission rate associated with HE STB link 150. In the event that local information stream 220 contains no information blank packets may be transmitted in place thereof. Further in accordance with the present exemplary embodiment a 20% increase in symbol rate is possible for the purpose of illustration. In many other applications, however, a much smaller symbol rate increase is sufficient to result in a significant amount of local information being transmitted. For example, given a bit stream of approximately 234,600 packets per second, and an additional 5 packets per second of local information, the overall increase in data rate is around 0.002% yet HE 140 may transmit an additional 5 kilobits per second of local information to STB 160. Because of the relatively small overall change in rate, it should be noted that no changes are required of hardware components associated with, for example, STB 160 such as transport hardware, demodulation hardware, and the like. Since the transmission rate of HE-STB link 150 is greater than that of broadcast information stream 210, it is preferably to ensure that the entire packet is received prior to retransmission resulting in some level of packet delay. Also, if the transmission rate of HE-STB link 150 is significantly more than that of broadcast information stream 210, packet starvation may occur in the outgoing stream buffers or queues. Thus although it is preferable to receive an entire packet before retransmission, it is sufficient in certain instances, e.g. when buffer or queue starvation is likely to occur, to receive enough bits to retransmit. Both of these situations, e.g. packet delay and buffer or queue starvation, however cause no difficulties and can be addressed by known measures such as, for example, selection of the transmission rate of HE-STB link 150, packet buffer management, and the like.

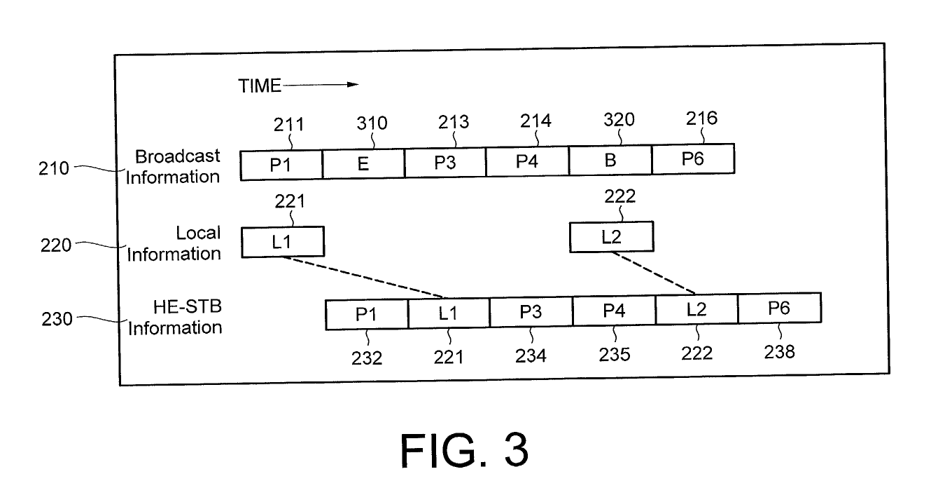

In accordance with Example 2 as described herein above, FIG. 3 illustrates inserting packet L1 221 and L2 222 of local information stream 220 into erroneous and blank packet locations. As can be seen, broadcast information stream 210 in FIG. 3 includes error packet 310 and blank packet 320 within the stream HE-STB stream 230 may be formed by inserting packet L1 221 in place of error packet 310 as illustrated and further inserting packet L2 222 in place of blank packet 320. It should be noted that HE 140 preferably demodulates and performs error correction coding on broadcast information stream 210 thus identifying, for example, erroneous packet 310 and blank packet 320 and may further add local information packets L1 221 and L2 222 as described performing further error encoding and modulation before sending out HE-STB information stream 230 to STB 160. It should further be noted that some packets may not be correctable during the initial demodulation and decoding process of HE 140 due to noise added, for example, in broadcast channel 120. Such packets may be termed erroneous packets and are of no use to STB 160. It should further be noted that dummy packets may be added to broadcast information stream 210 from time to time if the broadcast source is unable to maintain a constant symbol rate with its source information packets. In other words, dummy packets such as, for example, blank packet 320 may be used to fill empty bandwidth. Unneeded packets on the other hand may be those packets which are present in broadcast information stream 210 but do not apply to the local area market corresponding to user desired information 170.

For example, information contained in broadcast information stream 210 relating to local California markets would not be of interest in a user market in Washington, D.C. Accordingly packets containing such information within broadcast information stream 210 may be designated as unneeded by HE 140 thus allowing local information related to the Washington, D.C. user market to be inserted in place thereof. Alternatively, such packets could be dropped prior to broadcast and thus would appear as, for example, blank packets. It should be noted that blank packets are preferably substituted in order to maintain the proper symbol rate. Other packets which may be used for local information may include ranging packets, which packets are typically used by a system to measure distances by measuring end to end delay of the ranging packets. It should be noted that ranging packets provide no useful information to STB 160. It should also be noted that information on whether a packet is erroneous should be available after a demodulation decoding stage in HE 140 and may be reassigned immediately after such step. Dummy and ranging packets on the other hand have fixed contents and thus may be identified at some point after the modulation and decoding upon examination of packet header contents. It should still further be noted that since blank or unneeded packets are originally part of broadcast information stream 210, no timing considerations need to be addressed. If local information bandwidth requirements exceed available bandwidth associated with blank or unneeded packets in broadcast information stream 210, it may further be possible to adapt a hybrid technique which increases the rate of transmission on HE-STB link 160 only when it is determined that the available bandwidth associated with blank or unneeded packets is insufficient.

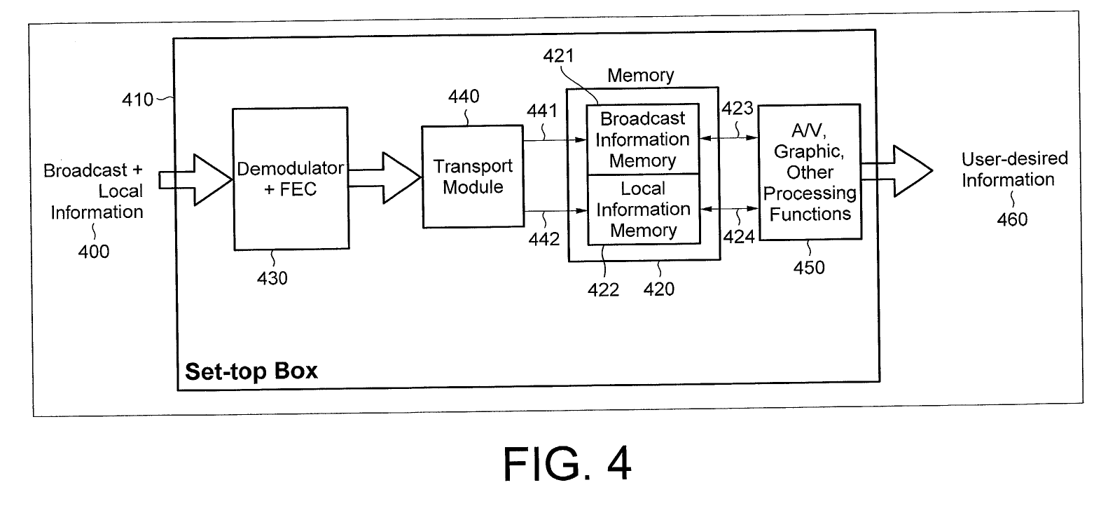

Thus as can be seen, for example, in FIG. 4 combined broadcast and local information stream 400 may be input to set-top box 410 to demodulator and FEC block 430. Packet headers of broadcast and local information stream 400 may include channel I.D. information or the like in a manner such that transport module 40 can discriminate between broadcast information and local information. Accordingly transport module 440 may “dump” appropriate contents into memory 420 by, for example, transferring local information along line 442 to local information memory 422 and transferring broadcast information on line 441 to broadcast information memory 421 such that any software applications as represented for example by processing function module 450 can access, for example, broadcast information memory 421 over line 423 and local information memory 422 on line 424, thus outputting user desired information 460 to a users output device, such as for example, a television, audio system, and the like.

The invention being thus described, it will be obvious that the invention may be modified in various ways. Such minor variations, however, are not to be regarded as a significant departure from the invention and all such modifications are intended, where appropriate, to fall within the scope of the appended claims.

What is claimed is:

1. A method for providing local information to a user device, the method comprising:
receiving a broadcast information stream at a first data rate at a headend;
inserting one or more packets from a local information stream into the broadcast information stream to form a combined information stream; and
transmitting the combined information stream to the user device at a second data rate.

2. The method according to claim 1, wherein the user device includes at least one of the following: a display, a computer, a VCR, a DVR, a set-top box, and a TV.

3. The method according to claim 1, wherein the first data rate is around 30Mbps and the second data rate is less than 100kbps.

4. A method for providing local information to a user device, the method comprising:
combining a broadcast information stream at a first data rate and a local information stream to form a combined information stream at a second data rate; and
receiving the combined information stream at the user device.

5. The method according to claim 4, wherein the user device includes at least one of the following: a display, a computer, a VCR, a DVR, a set-top box, and a TV.

6. The method according to claim 4, wherein the first data rate is around 30Mbps and the second data rate is less than 100kbps.

7. A method for providing local information to a user device, the method comprising:
receiving a broadcast information stream including one or more packets unusable to the user device;
inserting one or more local information packets in place of the unusable packets, to form a combined information stream; and
transmitting the combined information stream to the user device.

8. The method according to claim 7, wherein the user device includes at least one of the following: a display, a computer, a VCR, a DVR, a set-top box, and a TV.

9. The method according to claim 7, wherein the first data rate is around 30Mbps and the second data rate is less than 100kbps.

10. A system for providing local information to a user device, the system comprising:
a headend coupled to the user device;
a local information source coupled to the headend; and
a broadcast information source coupled to the headend, the system configured to:
receive a broadcast information stream from the broadcast information source at a first rate at the headend;
insert one or more packets from a local information stream from the local information source into the broadcast information stream to form a combined information stream; and
transmit the combined information stream to the user device at a second data rate.

11. The system according to claim 10, wherein the user device includes at least one of the following: a display, a computer, a VCR, a DVR, a set-top box, and a TV.

12. The system according to claim 10, wherein the first data rate is around 30Mbps and the second data rate is less than 100kbps.

13. A system for providing local information to a user device, the system comprising:
a broadcast information stream at a first data rate; and
a local information stream, the system configured to:
combine the broadcast information stream and the local information stream to form a combined information stream at a second data rate; and
receive the combined information stream at the user device.

14. The system according to claim 13, wherein the user device includes at least one of the following: a display, a computer, a VCR, a DVR, a set-top box, and a TV.

15. The system according to claim 13, wherein the first data rate is around 20Mbps and the second data rate is around 25Mbps.

16. A system for providing local information to a user device, the system comprising:
a headend coupled to the user device;
a local information source coupled to the headend; and
a broadcast information source coupled to the headend, the system configured to:
receive a broadcast information stream including one or more packets unneeded by the user device;
insert one or more local information packets in place of the unneeded packets, to form a combined information stream; and
transmit the combined information stream to the user device.

17. The system according to claim 16, wherein the user device includes at least one of the following: a display, a computer, a VCR, a DVR, a set-top box, and a TV.

18. The system according to claim 16, wherein the first data rate is around 30Mbps and the second data rate is less than 100kbps.

19. A broadcast information source configured to transmit a broadcast information stream, wherein one or more packets associated with a local information stream are inserted into one or more unneeded packet locations in the broadcast information stream.

20. A broadcast information source configured to transmit a broadcast information stream at a first data rate, wherein one or more packets associated with a local information stream are inserted into the broadcast information stream to form a combined information stream, the combined information stream transmitted at a second data rate different from the first data rate.
